(19) United States
(12) Patent Application Publication
(10) Pub. No.: US 2011/0173534 A1
(43) Pub. Date: Jul. 14, 2011

(54) Notification system for increasing user engagement

(75) Inventors: Kurt Hwa Huang, Mountain View, CA (US); Gyuchang Jun, Sunnyvale, CA (US); Duane Toyoichi Kuroda, Campbell, CA (US)

(73) Assignee: Peerspin, Inc, Mountain View, CA (US)

(21) Appl. No.: 12/861,680

(22) Filed: Aug. 23, 2010

Related U.S. Application Data
(60) Provisional application No. 61/235,971, filed on Aug. 21, 2009.

(51) Int. Cl. G06F 3/048; G06F 3/01

(52) U.S. Cl. 715/702; 715/764; 715/781; 715/786

(57) ABSTRACT

A content and context aware method and system taking one or more of multiple inputs based on user behavior, user context, content access times, content access frequency, or other settings and preferences to present one or more of multiple triggers to notify user of suggested actions or motivate users to take one or more suggested actions.

### RELATED APPLICATIONS

This application claims the benefit of U.S. Provisional Patent Application No. 61/235,971, filed on Aug. 21, 2009, entitled Notification system for increasing user engagement.

### BACKGROUND OF THE INVENTION

Online web applications have typically implemented two methods of notification. In the first, a web-page overlay over the current page a user is on, typically blocking the user from doing anything until they click something on the overlay to close the overlay. In the second, a toolbar, or browser add-on, plug-in, or extension is downloaded and installed, and updates and notifications are shown in the interface provided by the toolbar, or browser add-on, plug-in, or extension. This second group will be collectively referred to as toolbar or toolbar method.

In the first method, the notification method is usually activated by a “onload” type function, causing the overlay to appear after the document loads. In variations of that method, the overlay effect is sometimes modulated to appear after a fixed time or after the user has visited several web pages at the site. See the story “FT.com Considering iTunes-Style Micro-Payments Model” (http://paidcontent.org/article/419-ft.com-considering-itunes-style-micro-payments-model/). Notifications in the FT.com example have been used to instruct people to pay, whereas other notifications are typically used to inform users about new features, news, or other updates. In these methods, only one context is understood, that is “you, the user, are on this page”, where user action is needed to move forward, whether that is clicking “close”, “x”, or paying a day or other subscription fee.

In the toolbar method, users are required to download and install a toolbar that is usually associated with a website, where the toolbar uses public APIs or other methods to collect and present information to users of the toolbar. One disadvantage of the toolbar is that it must be downloaded and installed by each user who wishes to receive the notification or other information from the toolbar, where users who do not download and install the toolbar do not receive the benefits. The advantage, on the other hand, is that the toolbar method can also provide updates from multiple services, not just the site the user is on at the current time. In this form, the toolbar acts as a third party information, update, and notification aggregator, providing the notifications via a user installed application.

Recently, as toolbars have shown appeal to a limited set of users, sites like MySpace.com and Facebook.com use a web-based toolbar-like interface that provides a notifications, shortcuts, and access to functions on the respective sites. For example, both the MySpace and Facebook web-toolbars provide access to chat notifications and updates, but the MySpace one provides only updates from MySpace, and the Facebook one provides only updates from Facebook. These limitations are logical since the web-toolbars are designed and run by those companies and are hosted on their respective web servers, where web-toolbars are rendered using their javascript. The web-toolbars from MySpace and Facebook also appear in a different location, the bottom of the page at the bottom of the browser page.

The web notifications space has thus been defined by blocking overlays, toolbar, and web-toolbar implementations that block or partially block based on a limited set of conditions, where the notifications typically come from the site hosting the overlay or web-toolbar, and in certain cases delivered through a downloaded and installed toolbar.

Notifications have thus been limited either by technical know-how, lack of imagination, or other reasons not clear to the open market. One potential extension of notifications seems to start where web-toolbars leave off. The web-toolbar operating at the bottom of the page can be mistaken for text ads in a recently developed ad unit called the “catfish”. Described at Sitepoint (http://www.sitepoint.com/blogs/2005/10/18/the-catfish-part-1/), the catfish ad has been described as “Subtle yet effective” (http://catfishads.com/) due to the way it appears on a page. Variations on when the catfish ad appear have typically paralleled those of the overlay, however, which launches relative to the following: browser onload, after some fixed time, or after some fixed number of user actions.

In the above cases, there is little evidence to suggest that users of those systems are indeed notified or aware of the information or update communicated by the existing notification systems. An improved notification system is needed that extends beyond the limitations and actions developed and deployed by standard notification methods and new catfish style ad units. The notification should be tunable where administrators can affect the method and content of notification in real-time programmatically or manually and apply progressive mechanics of notification leveraging page context and position, user behavior, user rewards, publishers' preferences, content popularity, and user propensity to execute offers or pay in the activation of the notification.

### SUMMARY OF THE INVENTION

The invention lies in a method and system of delivering a first or third party notification system that uses one or more contextual cues including separate cues from components in the system to activate notifications that progressively increase salience or visibility of the notification while delivering additional context sensitive messaging, images, and other content to the user being notified.

### BRIEF DESCRIPTION OF THE DRAWINGS

FIG. 1 shows User interacting with various computing devices.

FIG. 1a shows user with desktop computer.

FIG. 1b shows user with laptop computer.

FIG. 1c shows user 100 with mobile phone or smart-phone.

FIG. 2 shows a system diagram of s computing device.

FIG. 3 shows computing devices connected to networks.

FIG. 4 shows example code and the location where the code should be placed for the widget component.

FIG. 5 shows two views of an article where the invention is rendered.

FIG. 6 shows a sample article page with the widget component.

FIG. 7 shows two examples of the widget and notification forms.

FIG. 8 shows three example renderings of the notifications bar form.

FIG. 9a shows an example article and reference points used for determining the actions and timing of the actions of the navigation bar.

FIG. 9b shows sample code used to implement the detection of elements in browser page.

FIG. 10 shows an example article with a larger notification bar component.

FIG. 11 shows the preferred embodiment of the notification bar component.

FIG. 12 shows the basic flow of the notification bar component.

FIG. 13 shows the flow of the notification bar component.

FIG. 14 shows a block diagram of the functional components.

FIG. 15 shows a logical block diagram of a system server, including several functional components.

FIG. 16 shows a basic communication diagram showing the basic communication of the system involving the widget component.

FIG. 17 shows a communication diagram.

### DESCRIPTION OF THE INVENTION

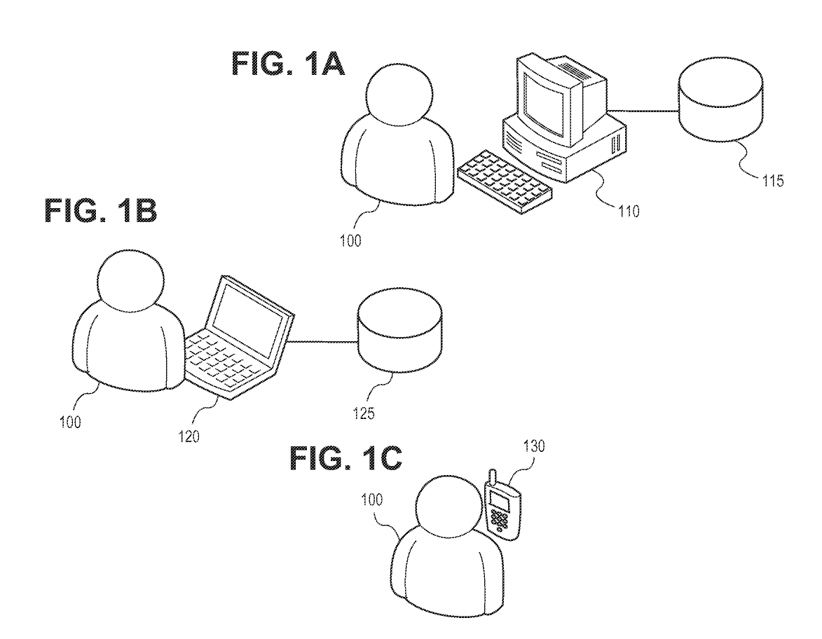

FIG. 1 shows User 100 interacting with various computing devices 110, 120, and 130 where the invention applies and may be deployed using local or remote storage. In this description, the term user and reader are used interchangeably, where a user=reader.

FIG. 1 a shows user 100 with desktop computer 110 which may use local storage or remote storage 115.

FIG. 1b shows user 100 with laptop computer 120 which may use local storage or remote storage 125

FIG. 1c shows user 100 with mobile phone or smart-phone 130.

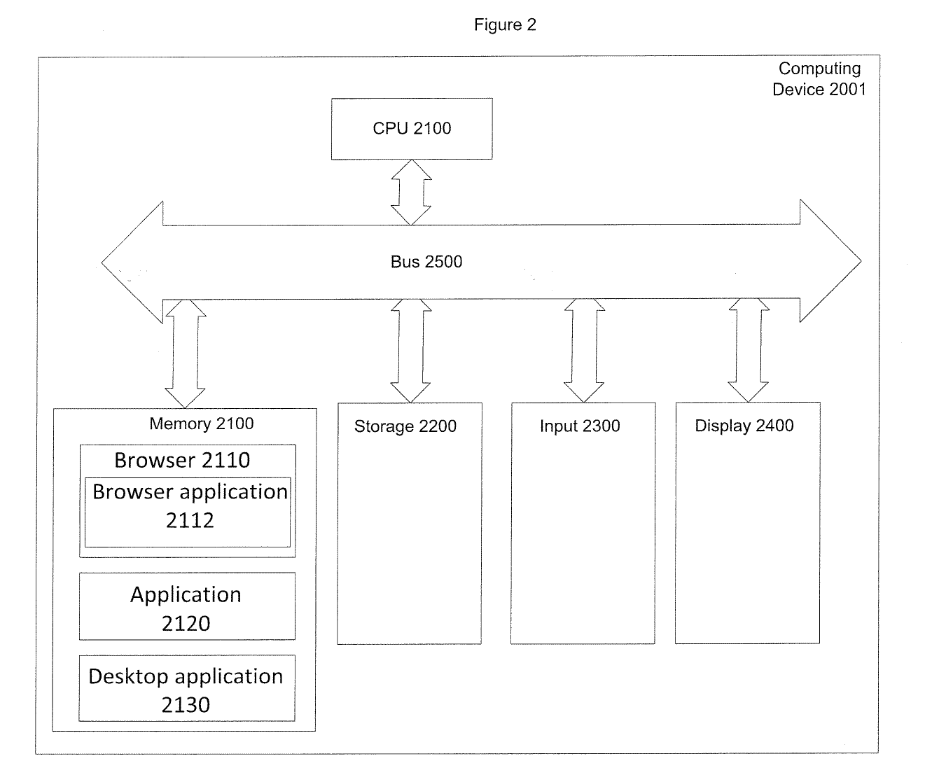

FIG. 2 shows a system diagram of computing device 2001, which may be any computing device from FIG. 1, where computing device 2001 includes components CPU 2100, Display 2400, Input devices 2300, longer term storage 2200 and short-term storage labeled memory 2100 connected by system bus 2500. The short-term memory 2100 or long-term memory 2200 can store the code which is run by CPU 2100 in short-term memory 2100, but may be run in longer term storage 2200. The invention may run as application 2120 which may be a service that runs at startup, runtime, shutdown, or other times or events, may run as a desktop application 2130, or run as a browser application 2112, where browser application 2112 runs in browser 2110, which is itself a desktop application or system service. The invention may run as a browser application 2112 written in programming or scripting languages including, but not limited to javascript, actionscript, adobe flash, adobe flex, vbscript, and others, or as an application written in programming or scripting languages, including, but not limited to C, C++, Perl, Python, Java, Visual Basic, Ruby, javascript, actionscript, adobe flash, adobe flex, vbscript and others. In a preferred embodiment, the invention is written in Javascript and runs as a browser application to enable easy installation.

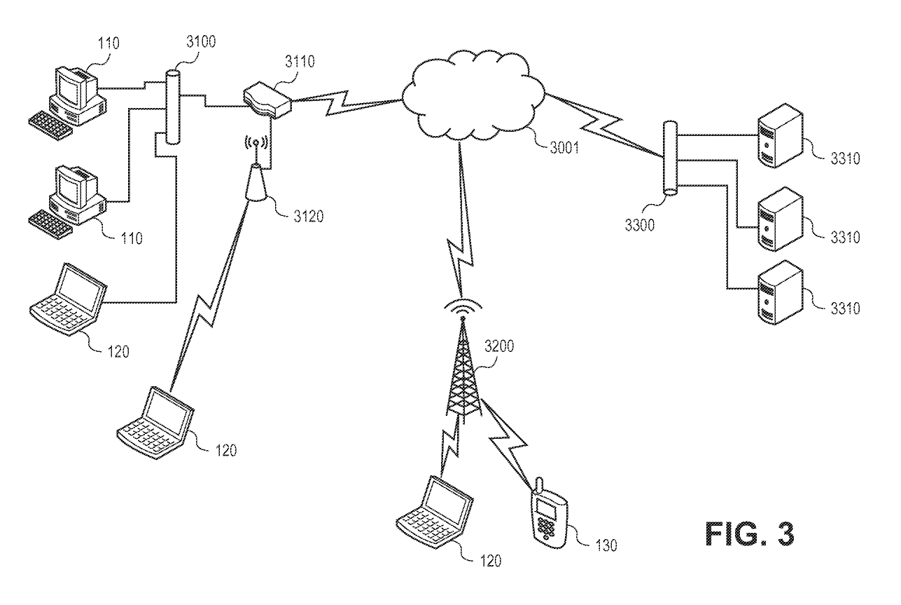

FIG. 3 shows computing devices 110, 120, and 130 connected to networks 3300 where computing devices 3310 may remotely host the code of the invention. The code may also be downloaded and installed on an individual computing device such that networks, remote servers, and remote storage are not necessary. In a preferred embodiment, computing devices connect through local networks 3100, wireless access points 3120, and wireless networks 3200, where routers 3110 can direct the code of the invention to the appropriate computing devices through larger networks 3001 such as the Internet using standard protocols including but not limited to HTTP, TCP/IP as other non-standard protocols.

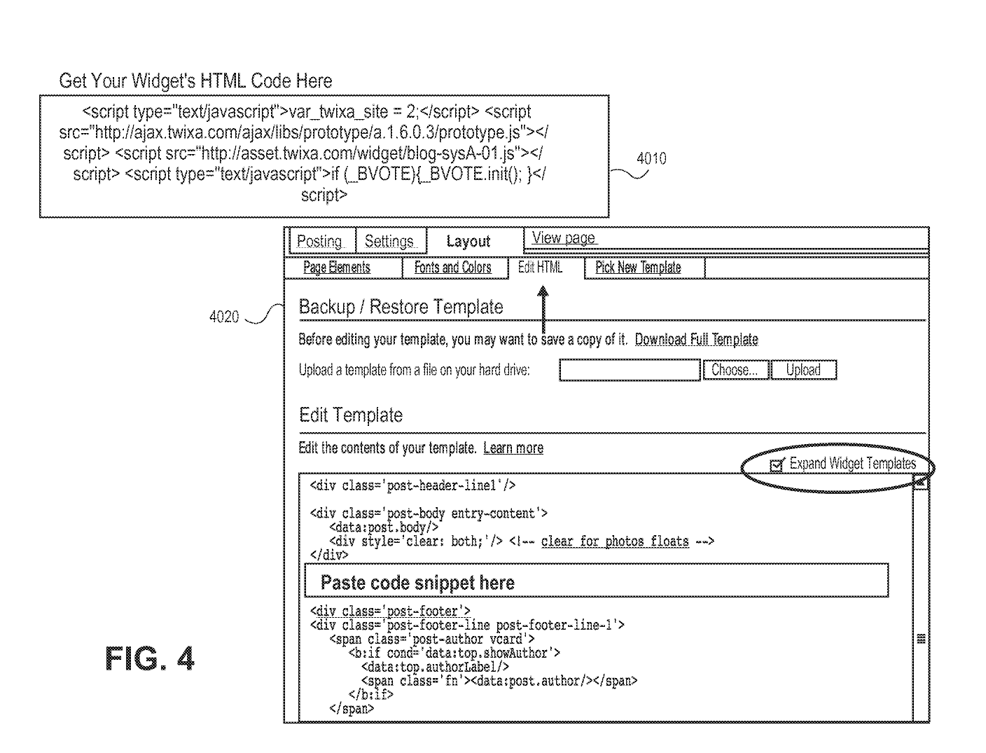

FIG. 4 shows example code and the location where the code should be placed for the widget component of the invention and the notification form of the invention to appear. Placement or insertion of the code can be done manually or automatically via the use of an installer, where the code is inserted into a templating system, blog system, content management system (CMS), online article system, news publishing system, video content delivery system, audio content delivery system, or other system designed for the purpose of providing structured entry and publishing of content in article or blog form. Content includes but is not limited to textual content, publisher content, electronic books, publicly available web content, and passive content.

4010 shows a code snippet box, where an installer would get the code snippet to put on their server where the invention would operate. The code in 41010 represents the javascript of the invention and contains the logic, scripting elements, visual and presentation elements, and identifiers necessary to operate the invention as described. The code from 4010 would be copied from an account management console or dashboard labeled to indicate that the code was necessary for the invention. The code shown is a sample only, where actual operating code for the invention may be the same, slightly changed, or significantly changed to provide current and/or future services related to the invention. The use of account management dashboards and HTML snippets for copy and paste are common activities and do not need additional elaboration. The code 4010 is then pasted into installer's web page, blog template, or CMS as HTML, into PHP or other web programming language, where adjustment or transformations may be necessary, or into a blog system or CMS which may handle programmatic insertion of the code at the appropriate time and location when the web page renders. In a preferred embodiment, code 4010 would be pasted into a blog or CMS which would use the code snipped directly without alteration in most cases. The code would be placed in a location in the CMS or blog template, where the location for placement would be provided by the site or content management tool. For the purposes of this description, the javascript of the invention should be understood to include the code that causes a widget component of the invention to render and operate as described as well as the notification bar component of the invention. The notification bar of the invention operates as a trigger or call to action for users wherein the notification is a window positioned at locations including but not limited to an edge of a display screen displaying content, a location that partially obstructs viewing of content, or a location proximate content. The javascript of the invention acts to augment a browser web page so that input from user or other elements of user context can be used to invoke a trigger, such as a notification bar, or to display a second window containing a user voting interface.

4020 is an example placement of the code into a template for the blogger system, where usage of the snippet or snippet variation can be used with blogging tools including but not limited to blogger, TypePad, Wordpress, Moveable Type, and more. The suggested placement of the javascript of the invention in the example before the text in 4020 shown as “<div class=‘post-footer’> is designed to insert a widget into each article at the end of the article content, before the footer as well as include the code for business and presentation logic controlling the appearance of the notification bar element of the invention. Therefore, a widget is rendered for each and every article, in the context of the article at the end of the article. In additional embodiments, such as shown in FIG. 7 and FIG. 8, where the notification bar element of the invention is shown with voting elements, the widget element of the invention may not be placed directly in-line with the content, and instead the voting function of the widget may be wholly replaced voting in the notification bar element of the invention.

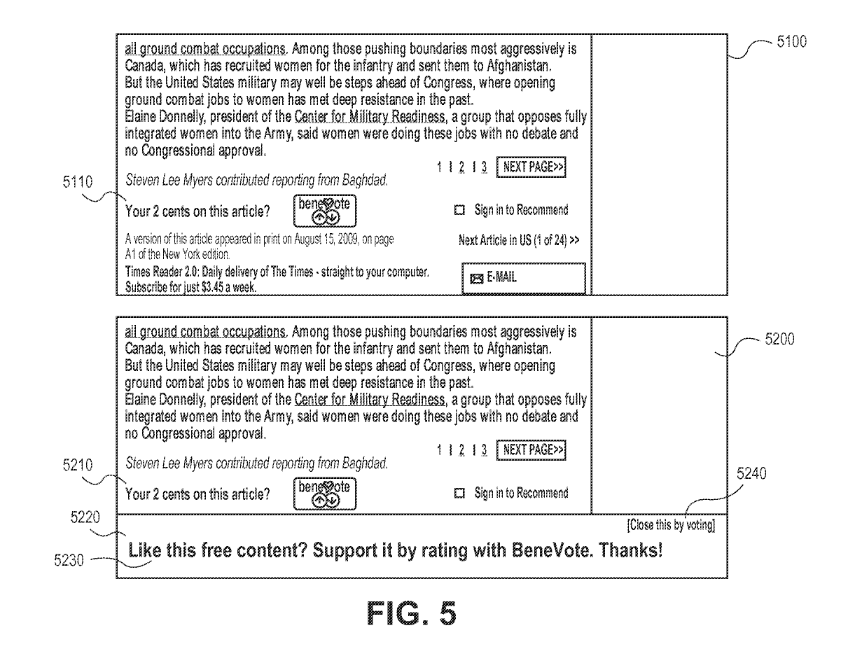

FIG. 5 shows two views of an article where the invention is rendered. In 5100, the widget component of the invention is rendered, with visual and text components of the widget component of the invention identified in 5110.

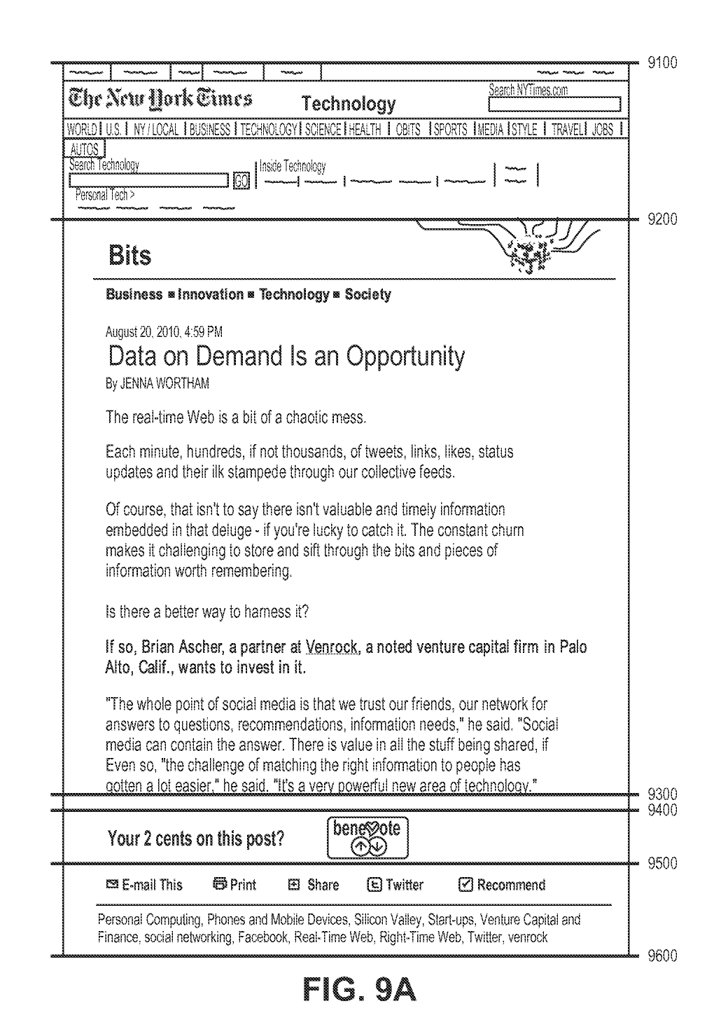

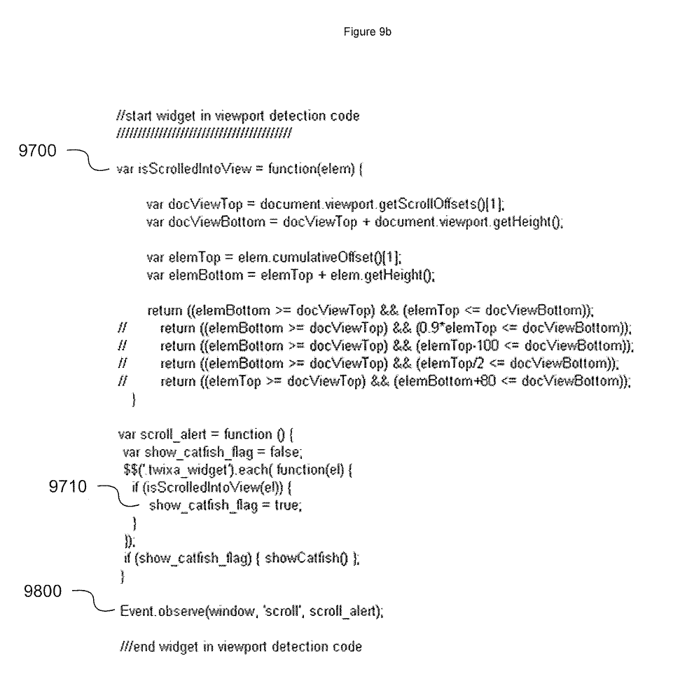

5200 shows an article where the widget component of the invention and the notification bar component of the invention are both visible. The widget component of the invention 5210 with text and images is shown, and the notification form of the invention is called out as 5220. The action or event that triggers a change of state from 5100 to 5200 will be more clearly explained in FIGS. 9a and 9b. 5220 is comprised of several components, where two are shown including, notification bar message 5230 and notification bar closure instructions 5240. Notification bar text and image content will be called out and described as clarification is needed.

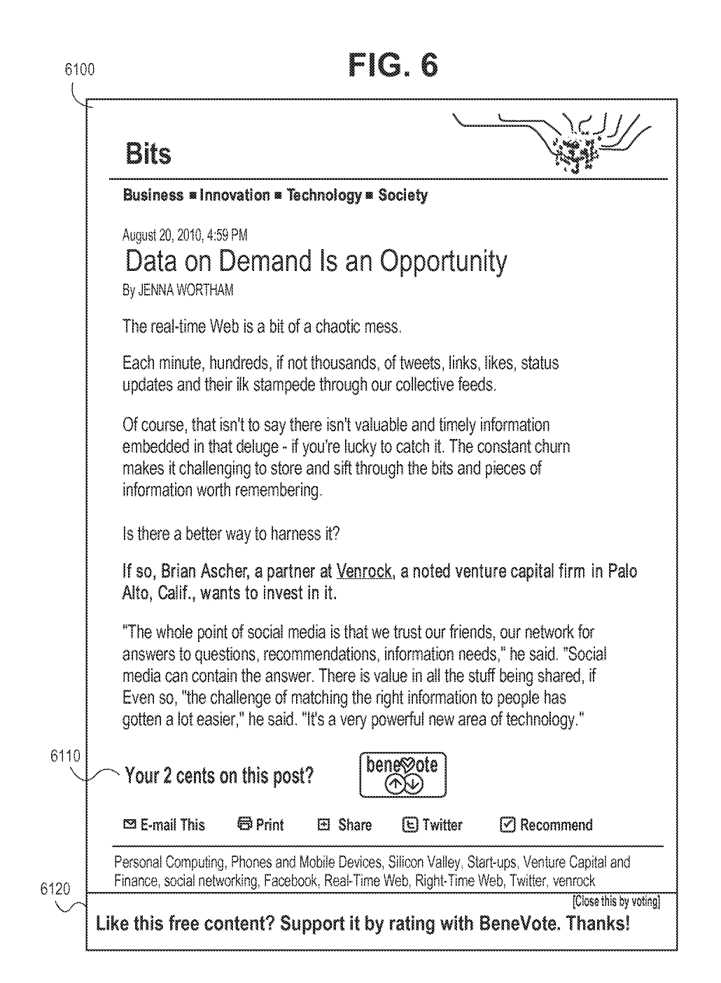

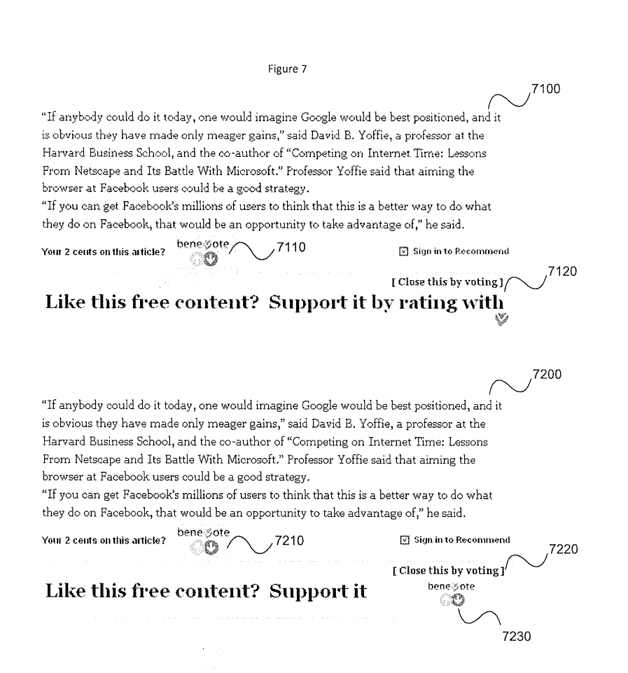

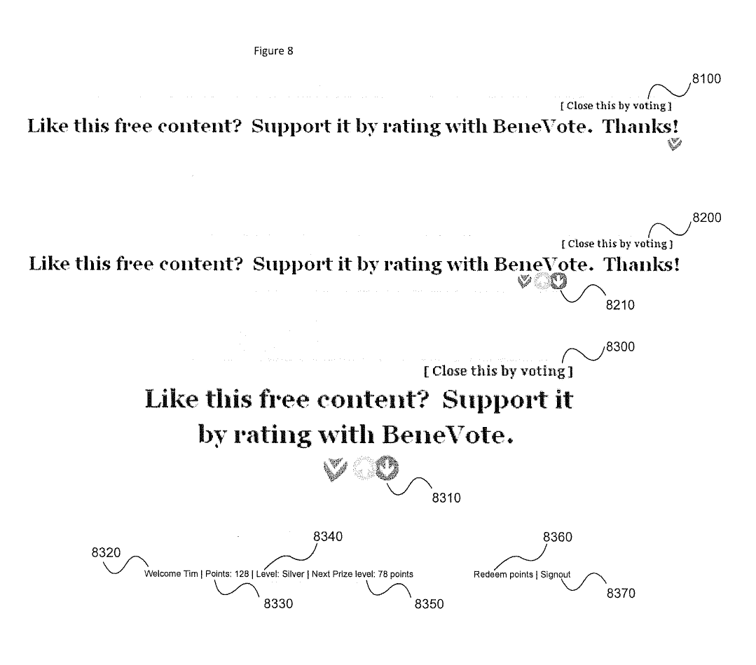

FIG. 6 shows a sample article page 6100 with the widget component of the invention 6110 and the notification bar from of the invention 6120. 6100 shows the widget and notification bar forms of the invention placed near the end of the article. 6100 represents any article, media, or content that a publisher wishes to monetize. The widget component of the invention 6110 can be placed at the beginning, middle, end or other location within an article. However, the widget component of the invention is shown at the end of the article in FIG. 6100 to symbolize the completion of the article, where the reader has completed reading of the article and has benefit of complete article information from which to cast his or her vote using the widget component of the invention.

The notification form of the invention, 6120, can also be made to display at any time or position during the reading of the article. In the preferred embodiment, the notification bar appears at a time and place conducive to increasing the chances of a user voting, which suggests a placement and revelation at or near the end of an article when the reader is done or almost done reading.

FIG. 7 shows two examples of the widget and notification forms of the invention rendered on the same article. 7100 represents an article where the invention applies. 7110 shows the widget component of the invention as rendered at the end of the article. 7120 shows the notification bar component of the invention rendered after the end of the article and below the widget component of the invention. 7120 appears over the content of the page, appearing in a dissolve, fade, scroll-in animation or other animation to increase the chances of being seen by the reader. The method and form of the appearance of the notification bar can be set to appear in a standard way, or may be customized based on a series of supplied parameters or may apply an algorithm or other set of rules to determine if, when, and how the notification bar appears.

7200 represents the same article as 7100, utilizing the same rendered form of the widget component of the invention 7210, but a different form of the notification bar 7220. 7220 can be modified to include a direct voting mechanism 7230, which may look like 7210 and operate in the same manner as 7210, and may even replace the need for the appearance of 7210. The use of 7230 in the notification bar is an option designed to increase the ability of the reader to vote by providing an additional context or context reminder of to vote. 7230 may exactly replicate 7210, but as shown in later figures, the functions of 7230 may be accomplished with fewer graphical elements in a notification bar 7220. For example, FIG. 8 shows another version where voting may be accomplished directly in the notification bar.

FIG. 8 shows three example renderings of the notifications bar form of the invention, where 8100 represents a basic form of the notifications bar that simply appears at the right time and/or context during article reading.

8200 shows a version of the notification bar component of the invention that includes voting arrows in the notification bar, shown as 8210. The form shown in 8210 does not exactly duplicate the widget component of the invention shown in FIG. 7, and purposely so. 8210 provides the basic voting interface of the widget component of the invention, where voting can be accepted on the widget component of the invention or in the notification form of the invention. 8210 has the benefit that while the voting interface is available in the notification bar, it does not exactly duplicate the widget and may thus be more pleasing and possibly less confusing to the reader.

8300 shows another rendering of the notification bar component of the invention. This version includes voting interface 8310, which provides the same function as 8210 for voting, but also provides additional engagement, personalization, and actions for the user. 8300 in this, the preferred embodiment, provides more vertical area for the notification bar, which also allows for the inclusion of the additional information. Additional information includes, but is not limited to welcome message 8320, points or rewards amount 8330, point level or class 8340, next level indicator 8350, redeem rewards link 8360, and signout 8370.

Welcome message 8320, is a programmatically generated message that includes the users name based on cookie or server-side authentication of the user.

Points or rewards amount 8330, represents points and rewards earned by the current logged in reader, where points were accrued through voting or other actions or interactions with the system, other users, or other offers.

Point level or class 8340, shows the points accrued and level achieved by a logged in reader. The point level or class grants the reader a special status and provides privileges associated with that status. Uses vote or take other actions to gain points that allow the reader to graduate to higher and higher rewards levels with more benefits.

Next prize level indicator 8350 conveys to a logged in reader the amount of points necessary to attain the next highest status level which may hold additional privileges or benefits. 8350 is designed to increase the engagement and repeat interaction with the voting system and system as a whole.

Redeem points link 8360, which links information on how points may be redeemed, further increases engagement by the reader, but also provides convenience, allowing the reader to quickly access the catalog of items redeemable for points.

Sign-out link 8370 simply provides a way for a logged in user to logout. When the user is logged out, this link is replaced with one that says “login”. Similarly, when users are logged out, other user information shown in FIG. 8 is replaced by general information and/or up sells to login or create an account.

FIG. 9a shows an example article and reference points used for determining the actions and timing of the actions of the navigation bar form of the invention. Actions that invoke the notification bar include but are not limited to user's position in the access of content, time spent viewing or accessing content, frequency of performing a particular task, frequency of interaction with other user, time spent interacting with other users, time since last notification bar or trigger was rendered to user, time since last user interaction with notification or trigger, keywords of the article or searches that lead to the article, user content selection actions, past purchase activity, past voting activity, or other actions. After the reference points are described their use in the invention will be described.

9100 represents a starting point or top of the document. In an HTML page, this could be marked by a <body> tag or other markup intended for the purpose of identifying the start of presentation content.

9200 represents the starting point or top of the article. In HTML this section might be found by a div tag <div> and or header section text <h1> or <h2>. Other custom markup or even XML may be used to find this section where the section may delineate by a section tag or article tag <section> or <article>. While the exact markup terms used herein may not match an implementation exactly, 9200 represents a general form of delineation identifying the start of an article that can be identified and used for calculations later.

9300 represents the end of the article text, and may be delineated in HMTL, XML, or other markup via section tags, div tags, close article tags (</article>, or even the start of the article footers. As before, any method that can be regularly used to delineate the end of the article text is important and may be used for calculations.

9400 represents the location of the top of the widget component of the invention, and should already be known or easy to find since it is part of the invention. When a widget component of the invention is inserted, it is inserted with regular code, including, but not limited to script <script> and div <div> tags that can be found, identified, and used in calculations later.

9500 represents the location of the bottom of the widget component of the invention, and should already be known or easy to find since it is part of the invention. When a widget component of the invention is inserted, it is inserted with regular code, including, but not limited to script <script> and div <div> tags that can be found, identified, and accessed since the regular code can be found at the start or end of the widget insertion in the code.

9600 represents the end of the article including footers and other article related code that may include but is not limited to sharing tools, printing, login/registration, comments, rating or ranking widgets and more.

The location of and sizes between various elements may be used to determine the rendering of the notification bar component of the invention. For example if we know the vertical location of 9500 and 9600, then the notification bar can be programmatically affected to take several actions including, but not limited to: being modified to fit in that space, being modified to use particular message to maximize usage of the particular space, or extend the size of the page to make the notification bar fit.

Likewise, if the vertical location of 9500 is known relative to 9100, we have the page top to bottom of widget. Then, if the notification bar is set to appear at 50% of the page top to bottom of widget height where visible page content acts as a viewport that may be detected, the notification bar can then be made to appear once a user scrolls to 50% of that height where user position may be detected by various methods including but not limited to x-y coordinates, cursor position, scroll bar position, position relative to viewport, or other positions that detect user focus by any number of input or tracking mechanisms that users may use to access content. The invention includes common javascript techniques in its code to determine the height, find 50% of it, then define an event/condition that will display the notification bar. It's important to note that while javascript on the page in the context of the content enables the activation of notification bar or other triggers that may be visible, audible, or vibrational in form, a notification bar is itself a trigger to encourage user action.

FIG. 9b shows sample code used to implement the detection of elements in browser page, where elements can be any element detectable on a browser page. In the preferred embodiment, the element for detection is the widget component of the invention, which is selected to provide the cleanest perceptive reference connecting the notification bar component of the invention to a voting widget component of the invention on the page.

9700 shows a sample procedure that is used to detect viewport top, viewport bottom, widget top, and widget bottom and return the status of the widget relative to the viewport when the position of the widget and viewport meet some position criteria. The same code returns ‘true’ when the widget scrolls or appears in the viewport, but a non-expansive set of position options are shown in the code and are commented out. Note that any elements can be used for position detection and that nothing is this document is intended to limit the elements which may be used for detection, and therefore triggering, of other elements and their actions in the invention.

9710 shows the call to the function to 9700 which detects the widget position. If the widget is detected in the proper position, a flag is set to then show the notification bar component of the invention. In this example the flag is called “show catfish flag”. Once the flag is set, other functions will display the notification bar component of the invention.

9800 shows sample code for an event listener which is called when the content in the page is scrolled. When the scroll has occurred, it calls an alert function which then calls another function to check if the widget is detected in the proper position.

Example code is example code and represents one of many ways to implement the invention, where example code shown here is intended to show developers normally skilled in the art how to detect required events and trigger the display of the notification bar component of the invention.

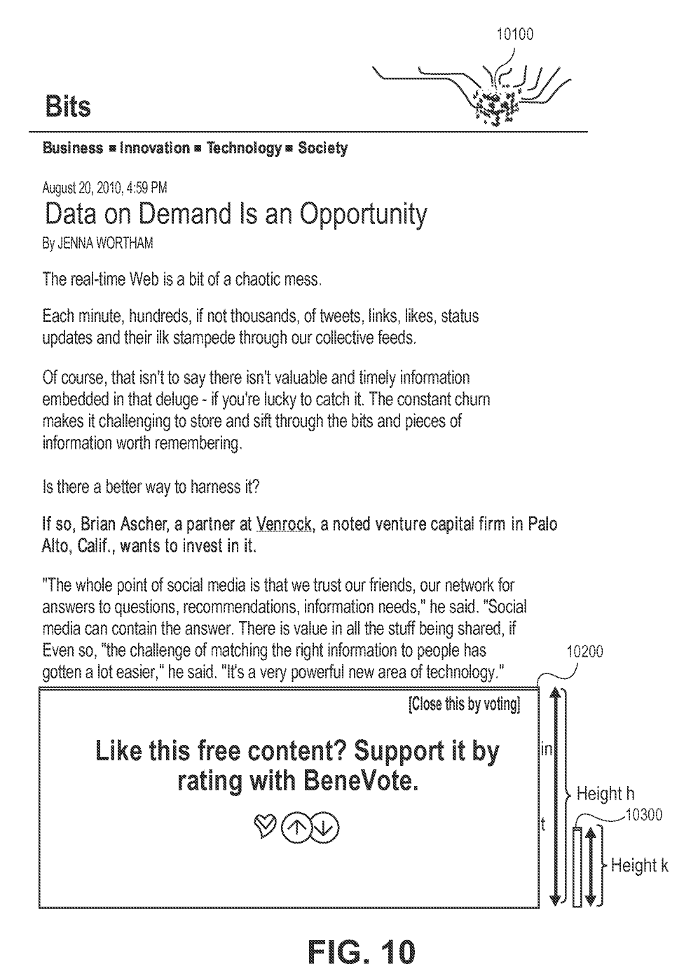

FIG. 10 shows an example article with a larger notification bar component of the invention. This situation may occur based on business logic to affect the reader's voting behavior. While the article 10100 may be readable in its entirety, the publisher may wish to encourage user voting which provides both feedback and potentially revenue to the publisher. Under a basic implementation of the notification bar component of the invention, the notification bar may appear (with message shown in FIG. 5) with height k shown at 10300. The notification bar with height k may not be visible enough, may be purposely ignored, or may not lead to votes for any of a number of reasons. If the same user reads several articles from the same publisher and doesn't vote, the reader has shown interest in the publisher and extracted value by reading several articles. In such a case, or for other reasons, the publisher may invoke a progressive notification feature. Over time, as a reader reads more articles from a publisher and doesn't vote, the notification bar increases in size, progressively occluding the content of the articles for that user at that particular publisher based on the number of articles read at that publisher. While full occlusion is not likely, the notification bar can be set to progressively occlude until the entire article is not readable. Note, that by voting on the notification bar the widget, the notification bar can be dismissed. Dismissal can be a time based, where a vote prevents the notification bar from appearing for a day, week, hour, or any fixed or variable time period. Dismissal can also be based on other factors including but not limited to: velocity of article reading, word count, readers overall point status, and more.

Height of the notification bar can set to programmatically increase in size based on number of articles read at single publisher, by the number of articles read by any publisher using the system of the invention, by time of day, article popularity or other factors. For example:

NotificationHeight=f(#publisher articles, # articles, time, article popularity, . . . n), where a simple specific implementation could be:

NotificationHeight=height1+((articlesRead−1)*2)*height1

### Using:

height1=100px
articlesRead=5
then,

### NotificationHeight=900px

So if reader did not vote on all of the five articles he/she read, the notification bar would be 900px high. Again, the example is simplified, but conveys a key concept that the notification bar can programmatically increase in size and occlude the article content based on actions or lack of actions by the reader. The actual algorithm used can be more or less complex, more or less aggressive, or non-existent, where the publisher does not progressively notify the user to vote.

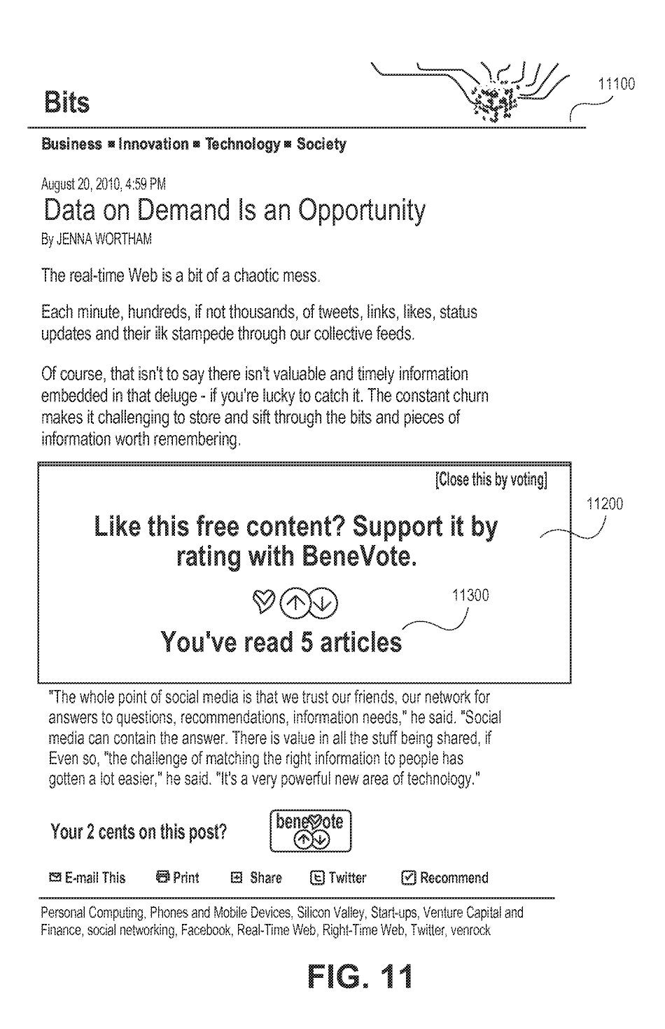

FIG. 11 shows the preferred embodiment of the notification bar component of the invention. Given article page 11100, a notification bar, if ignored, not only expands in size, but also changes location to take the form of 11200. This notification bar 11200 has expanded in size, based on a notification height equation, but also detaches and places itself over the content based on an independent formula or equation, a related equation, set of equations, or other logic.

Notification bar 11200 also includes a reminder 11300 in the notification bar, where the message used in reminder 11300 can be modified based on variable and factors including but not limited to preferred messages, random messages, on trial and error, known good language, or tuned to reader or content based on the reader, similar readers, keywords, or the content itself. Therefore, in this embodiment, the notification bar component of the invention can use multiple equations and business rules to notify, encourage, and even obscure content in an effort to encourage the user to comply and vote. While the techniques are applied to increasing voting rate, nothing is implied to limit the application of the technology and techniques to affect reader or user behavior to desired outcomes.

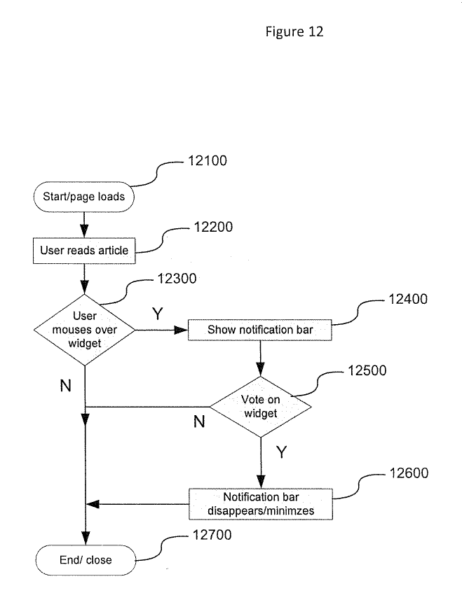

FIG. 12 shows the basic flow of the notification bar component of the invention and includes a notification bar rendering based on a widget interaction event.

12100 represents the start of the operation, where a web browser loads a page where the javascript code of the invention has been installed. When the web page with the javascript renders, appropriate event handlers are assigned to intercept and react to those events.

12200 represents the rendered article is being read by the user. The widget component of the invention is rendered on the page due to the javascript, but the notification bar component of the invention has not been rendered.

12300 represents a widget mouseover action, which occurs when a reader mouses over the widget component of the invention. An event handler is attached to the widget component of the invention, where one of the actions resulting from the widget mouse over is triggering the notification bar to display. The notification bar display can be instantaneous, as occurs when style parameters are changed from display:none to display: block, or display can take more complex renderings such as animations, where the notification bar is created below the visible viewport of the page, then scrolled in. Animation effects are not required, but can be helpful in increasing awareness of the notification bar. Note: based on business rules or contractual obligations, animation of the notification bar, may determine requirements of the operation of the notification bar, however, the technical invention can exist with or without animation.

12400 represents the notification bar entering the visible area of the browser viewport and becoming visible to the reader. The notification bar at this point typically includes components shown in FIGS. 8 and 8300.

12500 represents a reader action of voting on the widget component of the invention. The reader is presented with voting options such as up, down, or ratings stars where the reader interaction of clicking up, down, or any rating value is considered a vote. The voting result may be stored locally for rapid presentation, or stored remotely, after verification of the user, where voting results may be presented in numerical or non-numerical, such as graphical, form. Voting results may be used to increment or decrement local or remote, server based, article popularity indices, or applied to mathematical formulas locally or remotely to affect preference and relevance algorithms. An important point is that the invention is not limited to a specific algorithm or mathematical formula, rather that the act of voting and the voting context impact the decision flow, article indices, and preference and relevance algorithm outputs. More simply, preference and relevance of userX are functions of his/her vote up or down, article keywords and topics, userX's past votes, userX's past articles read, userX's past votes on articles, local time, revealed preferences, userX's ad click contexts, and other factors, where preference and relevance algorithms may be arbitrarily similar or different but based on best practices and current research.

12500 can also represent voting on a voting interface made available in the notification bar, where a voting widget component of the invention may or may not be visible in the browser viewport. While a mouseover action invoked an event handler which caused the notification bar component of the invention to appear, a ‘onclick’ or similar user interaction triggers another event handler to process the ‘widget clicked’ interaction. The notification bar can be made to disappear/hide or minimize, where a disappear action could be instantaneous, as occurs when style parameters are changed from display:block to display: none, or hiding/disappearing can take more complex renderings such as animations, where the notification bar may be moved below the visible viewport of the page when scrolled out. Animation effects are not required, but can be helpful in increasing awareness of the notification bar. Note: based on business rules or contractual obligations, animation of the notification bar, may determine requirements of the operation of the notification bar, however, the technical invention can exist with or without animation.

12600 represents the result of the vote 12500, where the notification bar component of the invention is hidden, partially hidden, or reduced to some minimal viewable form.

12700 represents the end of the article viewing, where a mouseover may or may not have occurred, but where a widget component of the invention was visible, and where the notification bar may have appeared based on mouseover or other interactions with the widget component of the invention.

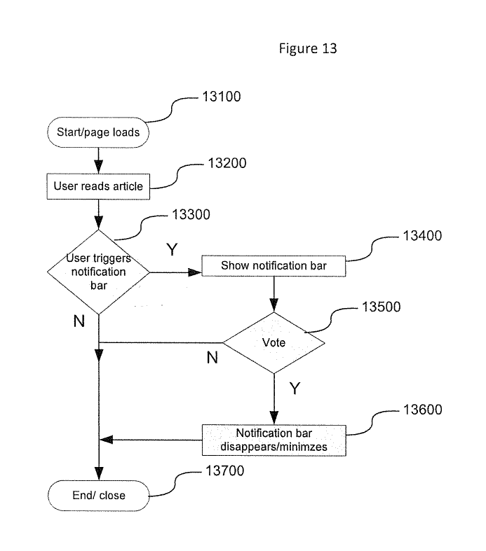

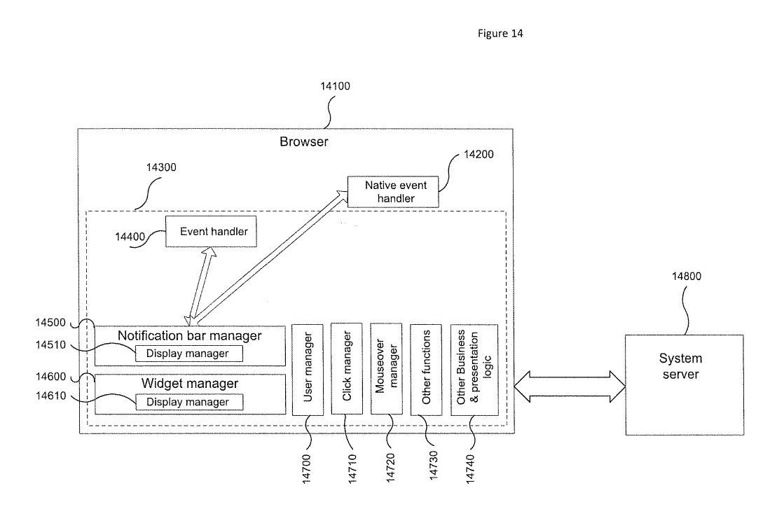

FIG. 13 shows the flow of the notification bar component of the invention and includes a notification bar display or rendering in the preferred embodiment.

13100 represents the start of the operation, where a web browser loads a page where the javascript code of the invention has been installed. When the web page with the javascript renders, appropriate event handlers, environment variable readers, business logic, and positional logic are run to detect context variables including, but not limited to absolute content position, content position in browser viewport, mouse position, widget position, scrolling position, scrolling speed, etc. whereby javascript code of the invention then determines positional or timing triggers assigns interceptable events to them that activate the notification bar of the invention.

For clarification purposes, a subset of interceptable event examples are provided.

### Example 1

On page 13100, an article footer is displayed. Javascript of the invention uses regular expressions to detect the HTML or XML code that signifies a footer such as <div class=‘footer’>, where any HTML or XML or other markup that signifies the start of the footer or end of an article, as a proxy of a footer can be used for detection.

### Example 2

On page 13100, a reader has reached 50% display of the article. Javascript of the invention uses position detection code shown FIG. 9b or regular expressions to detect the HTML or XML code that signifies the end of the article, where any HTML or XML or other markup that signifies end of an article, can be used for detection. There is no assumption that an end of article identifier is uniform, clear, or easy to find, and the system may thus have to be customized to properly identify the end of an article. However, there are several publishing, blog, and content management systems that do have regular structures that allow for automatic or nearly automatic identification of text blocks, section headers, and position within an article, browser viewport, or page in general, allowing for a direct and non-customized implementation where those systems are involved.

### Example 3

On page 13100, an article is displayed with a notification bar component of the invention appearing after 10 seconds. Javascript of the invention simply detects page load and starts a timer. The completion of the timer is an interceptable event that triggers a notification bar rendering or display. In this case the timeout itself can include the event handler.

### Example 4

On page 13100, an article is displayed with a notification bar component of the invention appearing after 10 seconds then checks if an article footer is displayed in a multi-event notification bar trigger. Javascript of the invention simply detects page load and starts a timer. The completion of the timer is an interceptable event that activates the event handler that fires when an article footer is displayed.

The javascript of the invention can provide a number of timers, event handlers, page, content, and reader action detection code to trigger a notification bar component of the invention to appear. Single or multiple events in specific or non-specific order can be used, and that information can be processed by javascript of the invention and/or the system server of the invention to customize or personalize messages and information in the notification bar component of the invention.

13200 represents the rendered article is being read by the user. The widget component of the invention is rendered on the page due to the javascript if necessary, but the notification bar component of the invention has not been rendered unless an interceptable event loaded in 13100 has been triggered during the page load due to article size or other reason, in which case the notification bar would be or becomes visible.

13300 represents if an interceptable event has been triggered. An event handler or series of handlers is attached to the interceptable events determined by the javascript of the invention, where any interceptable event causes the notification bar component of the invention to display. The notification bar display can be instantaneous, as occurs when style parameters are changed from display:none to display: block, or display can take more complex renderings such as animations, where the notification bar is created below the visible viewport of the page, then scrolled in Animation effects are not required, but can be helpful in increasing awareness of the notification bar. Note: based on business rules or contractual obligations, animation of the notification bar, may determine requirements of the operation of the notification bar, however, the technical invention can exist with or without animation. In the preferred embodiment, 13300 represents a trigger associated with the position of the widget component of the invention, as a available widget can serve as a service reminder and persistent interface to the functions and features of the system such as points, rewards, etc. in future embodiments, 13300 can refer to widgetless triggers, where javascript of the invention listens for other content, time, or page related events in singular or combination to trigger the notification bar component of the invention. In such cases, voting for 13500 can occur on the voting interface element on the notification bar as shown in FIG. 8.

13400 represents the notification bar entering the visible area of the browser viewport and becoming visible to the reader. The notification bar at this point typically includes components shown in FIG. 8 and FIG. 11, depending on how many times the reader has read articles and not voted.

13500 represents a reader action of voting on the widget component of the invention or interacting with a target object, where voting on the widget is preferred embodiment of the flow described here. The reader is presented with voting options such as up, down, or ratings stars where the reader interaction of clicking up, down, or any rating value is considered a vote. The voting result may be stored locally for rapid presentation, or stored remotely, after verification of the user, where voting results may be presented in numerical or non-numerical, such as graphical, form. Voting results may be used to increment or decrement local or remote, server based, article popularity indices, or applied to mathematical formulas locally or remotely to affect preference and relevance algorithms. An important point is that the invention is not limited to a specific algorithm or mathematical formula, rather that the act of voting and the voting context impact the decision flow, article indices, and preference and relevance algorithm outputs. More simply, preference and relevance of userX are functions of his/her vote up or down, article keywords and topics, userX's past votes, userX's past articles read, userX's past votes on articles, local time, revealed preferences, userX's ad click contexts, and other factors, where preference and relevance algorithms may be arbitrarily similar or different but based on best practices and current research.

13500 can also represent voting on a voting interface made available in the notification bar, where a voting widget component of the invention may or may not be visible in the browser viewport. While a mouseover action invoked an event handler which caused the notification bar component of the invention to appear, a ‘onclick’ or similar user interaction triggers another event handler to process the ‘widget clicked’ interaction. The notification bar can be made to disappear, hide or minimize, where a disappear action could be instantaneous, as occurs when style parameters are changed from display:block to display: none, or hiding/disappearing can take more complex renderings such as animations, where the notification bar may be moved below the visible viewport of the page when scrolled out. Animation effects are not required, but can be helpful in increasing awareness of the notification bar. Note: based on business rules or contractual obligations, animation of the notification bar, may determine requirements of the operation of the notification bar, however, the technical invention can exist with or without animation.

13600 represents the result of the vote 13500, where the notification bar component of the invention is hidden, partially hidden, or reduced to some minimal viewable form as determined by the event handler assigned to the voting widget or other object that activates the hiding or minimization action.

13700 represents the end of the article viewing, where one or several interceptable events may or may not have occurred. In the case where an interceptable event occurred, the notification bar component of the invention appeared, and in the case where an interceptable event did not occur, no notification bar occurred. Note that in the preferred embodiment, an interceptable event includes timing and time based events that may be trigger a notification bar rendering after a set time period after the page loaded in 13100, where time, sequence, movement, and interaction combined can comprise an interceptable event or events.

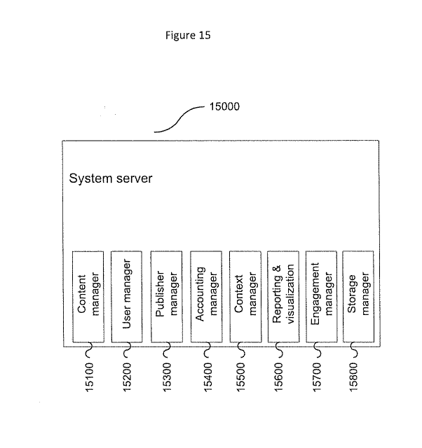

FIG. 14 shows a block diagram of the functional components of the invention. The functional blocks represent suggested, but not required organization of the functions activated or used during the operation of the invention. Each functional block may operate as stated, in conjunction with other functional blocks named, have their functions provided by other functional blocks named herein, or have their same sub functions from a functional block provided by other functional blocks named or not named in the figure. Combined functions may have the same name as one or more of the blocks shown, where overall functional capabilities may also be separated into lower level functions and split between named functional blocks. The functional blocks are used in combination to accomplish the capabilities of the invention, where a developer needs to understand the foundation of what is accomplished by the invention and can then create the invention based on similar, if not identical, functions that can inter-operate to provide the capabilities of the invention.

14100 represents a standard web browser that renders HTML and/or XHTML and includes industry standard scripting engines such as a javascript interpreter. A standard web browser includes the standard interfaces and protocol capabilities that enable the browser and it's plugins, addons, and extensions to communicate with the host computer and other computers not the host computers, including servers and other computing devices. The invention operates in standard web browser 14100, however future embodiments may enable similar capabilities in native desktop, mobile, or other application layer implementations.

14200 represents an event handler in standard web browser 14100. 14200 is native to the browser, and can be augmented by supplementary event handlers.

14300 represents the invention application space where the invention is implemented in javascript in the preferred embodiment and run in browser 14100's current scripting engine. The application code is inserted into a web page as shown earlier in FIG. 4 and activated and rendered during the rendering of the webpage where the code was inserted directly or via some template used to help manage content. The application space as created by interpreting javascript in the browser includes standard properties and methods that allow the javascript of the invention to add or modify DOM elements and style them using browser styles or cascading style sheets as necessary. Nothing in this description is intended to limit the scope, functions, or methods available to and used by the javascript of the invention.

14440 represents a local run time event handler that may or may not be used or called, but is made available by the javascript of the invention optionally as needed to extend or replace the capabilities and or functions of the existing Native event handler 14200. Functions in 14300 may use native event handler 14200, local event handler 14400, or both.

14500 represents a notification bar manager, which manages the actions, reactions, and behavior of the notification bar component of the invention. 14500 has it's own display manager 14510 which manages the rendering, display, hiding, placement and other presentation properties and actions of the notification bar via logic in the display manager 14520 and other functions 14700, 14710, 14720, 14730, and 14740.

14600 represents a widget manager, which manages the actions, reactions, and behavior of the widget component of the invention. 14500 it's own display manager 14610 which manages the rendering, display, hiding, placement and other presentation properties and actions of the widget via logic in the display manager 14620 and other functions 14700, 14710, 14720, 14730, and 14740.

14700 represents a user manager function responsible for identifying, validating, authorizing, saving, and managing user data for the invention. Using cookies and server calls, 14700 validates who the current user is by extracting data from the cookie or other session or local variables and communicates that with the system server 14800. 14700 determines the user state as either a registered logged-in user or as a user, not registered and logged-in. The second state is called a guest. 14700 presents appropriate user information depending on the state, including but not limited to the information shown and described for FIG. 8, but showing best guess information is there is a cookie to suggest the user status has somehow interacted with the system. Note, until a user is registered and logged in, the information presented to a guest is not presumed to be accurate or valid until verified by system server 14800.

14710 represents a click manager which manages the behaviors of clicks on the widget component of the invention or notification bar component of the invention. Clicks are interceptable events and result in zero, one, or more actions by the javascript of the invention depending on the events assigned to the click, where such clicks invoke such tasks including but not limited to: registering an up or down vote or rating, rendering an information bubble, redirecting the user to a page within or out of the bubble, within or in a new browser window or tab, launch another application, cause some value to be calculated, show/hide/ or cause the rendering of the notification bar, update the display and or messaging of the notification bar or widget. Actions resulting from the user manager may or may not be modulated state of the user.

14720 represents a Mouseover manager which manages the behaviors of mouseovers on the widget component of the invention or notification bar component of the invention. Mouseovers are interceptable events and result in zero, one, or more actions by the javascript of the invention depending on the events assigned to the mouseover, where such mouseovers invoke such tasks including but not limited to: registering an up or down vote or rating, rendering an information bubble, redirecting the user to a page within or out of the bubble, within or in a new browser window or tab, launch another application, cause some value to be calculated, show/hide/ or cause the rendering of the notification bar, update the display and or messaging of the notification bar or widget.

14730 represents other functions necessary to manage and accomplish necessary tasks of the invention as described in FIG. 12 and FIG. 13. 14730 represents basic functions that accomplish such tasks including but not limited to reading, setting, modify cookies, error handling, general timers, variable and memory management.

14740 represents other business and presentation logic necessary for special interactions and display of the widget component of the invention and/or notification bar component of the invention. 14740 works with display managers 14510 and 14610 to determine the position of content elements on the page that may trigger actions by the widget component of the invention or the notification bar component of the invention. As described in FIG. 9a, partial, complete, or relative display of page elements, browser elements, or elements of the invention, such as the widget or notification bar may trigger interceptable events that can be processed by 14700, 14710, and 14720 to display more, additional, new, or calculated information or content in conjunction with system server 14800 and other rules from 14740.

Example 1, if a reader of an article spends 10 seconds on the article, a “time spent” timer in 14740 would trigger if the time was set at 10 seconds. A result could be changing the style of the widget to change color for visibility or cause the notification bar of the invention to appear.

Example 2, if a reader is reading an article 100 lines long, and a the business logic in 14740 includes the rule “show notification bar when reader reads 50% of the article”, then the javascript of the invention runs and continually checks the reading percentage of the article. Once 50% of the article has been read, or 50 lines, have passed, the notification bar of the invention would appear. When the notification bar of the invention is triggered to appear, presentation rules in 14740 interact with notification display manager 14510 to make the notification bar appear using standard styles, CSS, or animation code from 14510 or 14740.

14800 represents a system server that communicates with the invention. There may be one or more system servers designed to respond to client side forms of the invention. Javascript of the invention is designed to run on client browsers on desktop, notebook, or other mobile computing devices, where one or more instances of a browser may operate with javascript of the invention on each computing device. There is no limit to the number of computing devices running the javascript of the invention, nor are there limits to the number of system servers 14800 of the invention. The number of servers should be chosen to make optimal use of resources that may change based on the operating and financial environment. System server 14800 provides interfaces, handshakes, and returns data the javascript of the invention 14300. User validation, user setting and preference management, publisher specific logic, javascript and HTML code delivery, accounting, storage, reporting, content management, context management, and visualization are all accomplished by 14800.

FIG. 15 shows a logical block diagram of a system server, including several functional components. The functional blocks represent suggested, but not required organization of the functions activated or used during the operation of the invention. Each functional block may operate as stated, in conjunction with other functional blocks named, have their functions provided by other functional blocks named herein, or have their same sub functions from a functional block provided by other functional blocks named or not named in the figure. Combined functions may have the same name as one or more of the blocks shown, where overall functional capabilities may also be separated into lower level functions and split between named functional blocks. The functional blocks are used in combination to accomplish the capabilities of the invention, where a developer needs to understand the foundation of what is accomplished by the invention and can then create the invention based on similar, if not identical, functions that can inter-operate to provide the capabilities of the invention.

15000 represents system server or servers that accomplish the functions of the system server in the invention. System server 15000 provides several functions including, but not limited to 15100, 15200, 15300, 15400, 15500, 15600, 15700, 15800, and other functions necessary to run and maintain system server 15000 reliably to function in the invention.

15100 represents a content manager which serves to organize, collect, manage, and deliver appropriate content to the javascript of the invention in the client web browser. Content includes, but is not limited to graphics, javascript or other code, CSS or style information, meta information, user data, publisher data, user engagement data, offer data, and advertising and ad data.

15200 represents a user manager which serves to manage user data for the invention. Several user actions and data are managed including but not limited to user validation, authentication, profiles, preferences, actions, rewards, points, history, and more.

15300 represents a publisher manager which serves to manage publisher data for the invention. Several publisher actions and data are managed, including but not limited to publisher authentication, publisher category, publisher engagement data, audience profile data, audience action profile, audience engagement and history data, and more.

15400 represents an accounting manager which serves to validate, record, and manage the data of the interactions of the system. Typical functions 15400 would provide include but are not limited to registering votes, tallying votes, vote and complaint settlement and reconciliation, vote exchange and transaction management, acquirer identification and credit assignment, publisher voting credit and assignment, user-publishers voting reconciliation, and more.

15500 represents a context manager which serves to detect and react to name contexts, rules based contexts, and categorized contexts. Based on any of the following individually or in combination: URL, Publisher, reader, voting history, system cookie read by javascript of the invention, system gestures, and other conditional variables, 15500 may detect an actionable context and send additional business rules, formatting, media, or content to the javascript of the invention to positively enhance the presentation to the reader and increase engagement by voting or other interaction.

Example 1a new rule is entered into the system via form submission or an updated .txt file. The new rule states that all readers who read articles in the micropayments category and vote more than once will receive 1 extra point when they vote and become immediately eligible to receive an invite to a service normally requiring 10 points. 15500 could immediately signal via an ajax call to update the message in the widget and notification bar forms of the invention. If the reader votes, their immediate eligibility would be processed by 15500, 15700, 15400, and 15200 to correctly account for the vote and deliver invite notification of eligibility.

15600 represents a report and visualization manager which serves to create, store, and manage reports for system administrators, publishers, and users. Reports and visualizations will be implemented to allow manual adjustment of engagement properties in the engagement manager 15700 by reviewing report and visualization data of the contexts, situation, user, article, and publisher data and how users behave differently based on those data sets. In future embodiments, interaction with the visualization manager will be used t proactively modify parameters and algorithms in the engagement manager.

15700 represents an engagement manager which serves to implement manual or algorithmic rules to affect user engagement. Engagement metrics such as voting rate may be influenced by parameters including but not limited to: timing for the notification bar component of the invention to appear, how much of the article is read before the notification bar appears, how the widget component of the invention and notification bar interact, widget and notification bar messaging, timing, graphic content, and more. Using 15700, the user experience can be tailored to be the same for all publishers, only articles for one or a few publishers, a set of publishers, a category or article, or for users who fit a certain profile.

15800 represents a storage manager which manages and stores user, data, profile, and other data for immediate term, short term, and longer terms access and storage. Data, content, and assets can be stored in frequently accessed cache, regular RAM, or on disk on the system server or other storage systems designed for such functions.

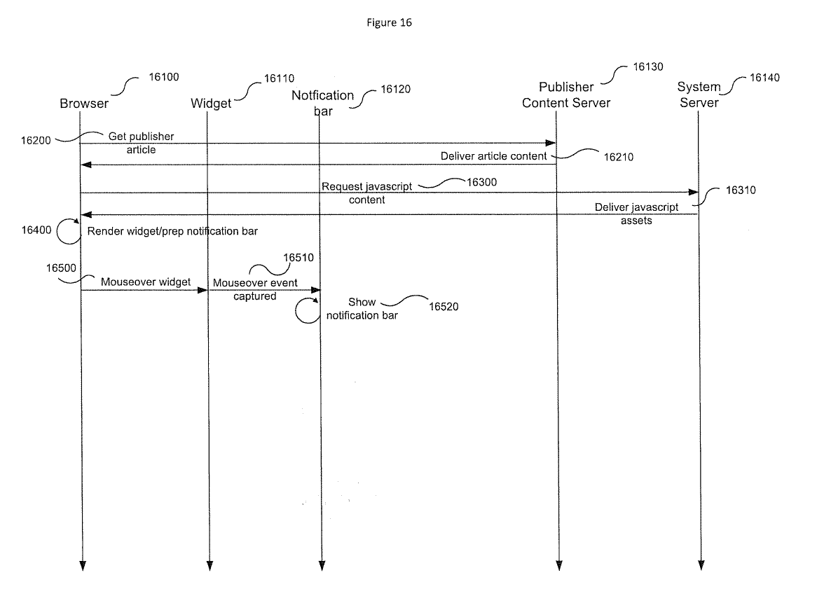

FIG. 16 shows a basic communication diagram showing the basic communication of the system involving the widget component of the invention 16110, web browser 16100, notification bar component of the invention 16120, publisher's content server 16130, and the system server 16140. This basic communication diagram shows a minimal implementation case from which a developer can extend to more complex cases.

Browser 16100 represents the preferred application vehicle for the embodiment, where the javascript of the invention runs as a browser application rendering the widget component of the invention and notification bar component of the invention. The web browser 16100 may be a browser on any computing device including desktop, laptop, or mobile computers or phones equipped to access content on publisher's servers on public or proprietary networks. Common browsers include Mozilla Firefox, Microsoft Internet Explorer, Opera, Google Chrome, and Apple Safari.

Widget 16110 represents the user facing, browser rendered component of the invention. For purposes of this diagram, browser functions downloaded and installed as part of the widget are described as coming from the widget component of the invention.

Notification bar 16120 represents the user facing, browser rendered notification component of the invention. For purposes of this diagram, browser functions downloaded and installed as part of the notification bar are described as coming from the notification bar component of the invention.

Publisher content server 16130 represents the installer of the javascript of the invention which renders widget 16110 and notification bar 16120. Publisher 16130 uses the invention to collect votes on articles and content, encourage readers to vote often, earn advertising or other revenue, and collect statistics.

System server 16140 represents a server or group of servers used to provide services for the invention, including but not limited content delivery servers, visual asset delivery servers, database servers, accounting and analytics servers, relevance and context analysis servers, and code delivery servers. Servers delivering content, code, or other assets are treated as logical elements even though the exact functions may be distributed or combined over several servers.

16200 represents a page request initiated by a reader and sent by reader's browser to fetch a page from the publisher's site which has the javascript of the invention installed.

16210 shows the page contents being delivered to the requesting browser 16200. The page contents include code and links to additional code for the javascript of the invention, which is sourced from system servers 16140.

16300 shows the browser requesting additional content and code specified in the links and content specified in 16210. Additional javascript of the invention includes code for the widget 16110 and notification bar 16120, retrieving it from system servers 16140.

16310 shows the system servers 16140 responding and delivering the javascript of the invention which includes code for widget 16110 and notification bar 16120 for execution and/or rendering at browser 16100.

16400 shows the browser rendering widget 16110 and preparing to render notification bar 16120.

When browser 16100 detects a mouseover event over the widget 16500, browser executes the javascript of the invention associated with the onmouseover event tied to the widget object. Mouseover events are executed by widget mouseover handler 16510, which executes business logic to affect the look and feel of the widget and also triggers the display of notification bar 16120. While widget mouseover handler 16510 triggers the display of the notification bar, in the preferred embodiment, other functions designed to increase interactions such as voting on the widget are triggered in addition to the display of the notification bar. These other functions include, but are not limited to: showing additional information about the service that the widget supports, influential messaging, user status, user rank, and include other functions affecting logic execution or presentation.

Mouseover event 16510 then triggers javascript of the invention to show the notification bar 16520, where the display of the notification bar can appear instantly, or non-instantly. Non-instant displays can include time delays, animation, or other effects designed to improve the visual experience of the reader and improve voting and similar interactions.

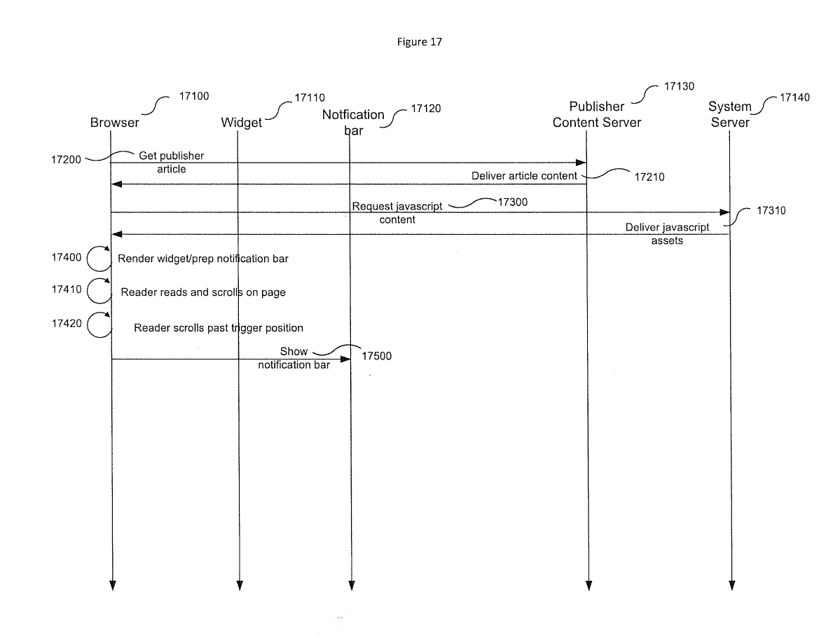

FIG. 17 shows a communication diagram showing the preferred embodiment of the communication of the system involving the widget component of the invention 17110, web browser 17100, notification bar component of the invention 17120, publisher's content server 17130, and the system server 17140. This communication diagram shows a more involved implementation case that in FIG. 16 from which a developer can extend to more complex cases.

Browser 17100 represents the preferred application vehicle for the embodiment, where the javascript of the invention runs as a browser application rendering the widget component of the invention and notification bar component of the invention. The web browser 17100 may be a browser on any computing device including desktop, laptop, or mobile computers or phones equipped to access content on publisher's servers on public or proprietary networks. Common browsers include Mozilla Firefox, Microsoft Internet Explorer, Opera, Google Chrome, and Apple Safari.

Widget 17110 represents the user facing, browser rendered component of the invention. For purposes of this diagram, browser functions downloaded and installed as part of the widget are described as coming from the widget component of the invention.

Notification bar 17120 represents the user facing, browser rendered notification component of the invention. For purposes of this diagram, browser functions downloaded and installed as part of the notification bar are described as coming from the notification bar component of the invention.

Publisher content server 17130 represents the installer of the javascript of the invention which renders widget 17110 and notification bar 17120. Publisher 17130 uses the invention to collect votes on articles and content, encourage readers to vote often, earn advertising or other revenue, and collect statistics.

System server 17140 represents a server or group of servers used to provide services for the invention, including but not limited content delivery servers, visual asset delivery servers, database servers, accounting and analytics servers, relevance and context analysis servers, and code delivery servers. Servers delivering content, code, or other assets are treated as logical elements even though the exact functions may be distributed or combined over several servers.

17200 represents a page request initiated by a reader and sent by reader's browser to fetch a page from the publisher's site which has the javascript of the invention embedded.

17210 shows the page contents being delivered to the requesting browser 17200. The page contents include code and links to additional code for the javascript of the invention, which is sourced from system servers 17140.

17300 shows the browser requesting additional content and code specified in the links and content specified in 17210. Additional javascript of the invention includes code for the widget 17110 and notification bar 17120, retrieving it from system servers 17140.

17310 shows the system servers 17140 responding and delivering the javascript of the invention which includes code for widget 17110 and notification bar 17120 for execution and/or rendering at browser 17100.

17400 shows the browser rendering widget 17110 and preparing to render notification bar 17120. At this stage, javascript of the invention is running in browser 17100, where article position detection code is running and looking for events to trigger the display of notification bar 17120. As discussed with FIG. 9a, javascript of the invention can be set to trigger a notification bar display event based on certain positional parameters such as 50% of the article is read, 80% of the article is read, the widget is visible, etc.

17410 represents when the javascript of the invention has loaded and is being run on the page in the browser, when a reader interacts with the page, reading and/or scrolling on the page to view the content of the article. Actions in 17410 occur before any trigger occurs based on positional parameters or timing parameters.

17420 represents when the javascript of the invention has loaded and is being run on the page in the browser, when a reader interacts with the page causing it display content at or past some trigger point based on positional parameters such as 50% of the article, 80% or the article, the widget is visible etc. When the trigger point is activated, javascript of the invention fires an event which causes the notification bar 17120 to render. It's important to note that FIG. 17 operates nearly identically and more simply for timing based parameters than positional based parameters, where 17420, in a timing based parameter setting activates when a timer has expired, triggering the display of the notification bar.

17500 represents the display of the notification bar component of the invention. Notification bar 17120 can consist of text and graphics that may be hard coded into the javascript code, sourced in real-time from system server 17140 and cookies, or a combination of hard coded and dynamic real-time text and graphics. In the preferred embodiment, the notification bar 17120 displays hard coded text and graphics unless the system server or a local cookie instructs, includes dynamic information, or provides real-time information to be displayed in the notification bar.

1. A computer-implemented method comprising:
displaying content to a user;
determining a context associated with the user's behavior; and
rendering a trigger for the user based on the context.

2. A method according to claim 1, wherein the content is associated with one of:
a content management system,
a blogging system,
an online article system,
a news publishing system,
an audio content delivery system, and
a video content delivery system.

3. A method according to claim 1, wherein the content is one of textual content, publisher content, an electronic book, public web content, and passive content.

4. A method according to claim 1, wherein the trigger is a window positioned at one of an edge of a display screen displaying the content, a location that partially obstructs viewing of the content, and a location proximate the content.

5. A method according to claim 1, wherein the trigger is one of an audible sound and a vibrational movement.

6. A method according to claim 1, wherein the trigger is a call to action for the user.

7. A method according to claim 1, wherein the trigger is rendered based on a user's location within the content.

8. A method according to claim 7, wherein the user's location is based on one of a location of a pointing device operated by the user, a viewport operated by the user, and a scroll bar operated by the user.

9. A method according to claim 8, wherein the pointing device is a cursor operated by the user.

10. A method according to claim 1, wherein the trigger is rendered based on a user action.

11. A method according to claim 10, wherein the user action is one of content viewed, activities performed, keywords used, selections, purchase activity, and voting activity.

12. A method according to claim 10, wherein the user action is one of:
time spent viewing particular content,
frequency of performing a particular task,
frequency of interaction with other users,
time spent interacting with other users,
time since last trigger was rendered to the user, and
time since last user interaction with the trigger.

13. A method as recited in claim 4 further comprising displaying a second window, wherein the second window includes a user voting interface.

14. A method as recited in claim 13 wherein activation of the user voting interface by the user closes the window.

15. A method as recited in claim 1 further comprising identifying a plurality of reference points in the content.

16. A method as recited in claim 15 wherein the reference points are used to determine one of a time at which the window is displayed, a location to display a window, a size of a window, a start of the content, and an end of the content.

17. A method as recited in claim 15 further comprising:
determining a size of the window based on at least one of the reference points;
and
selecting content for the window based on the determined size of the window.

18. A method as recited in claim 1 wherein the trigger changes based on a time spent viewing content by the user or based on a quantity of content viewed by the user.

19. A method as recited in claim 4 wherein a position of the window changes based on a time spent viewing content by the user or based on a quantity of content viewed by the user.

20. A computer-implemented method comprising:
displaying content to a user;
determining a context associated with the user's behavior;
identifying additional content having a similar context as the displayed content;
displaying a first window containing the additional content proximate the displayed content; and
displaying a second window containing a user voting interface.
